(19) United States
(12) Patent Application Publication
(10) Pub. No.: US 2015/0011144 A1
(43) Pub. Date: Jan. 8, 2015

(54) MULTI-FUNCTION MEAT TENDERIZING MALLET

(71) Applicant: Wiktor E. Gorowski, Koszyce Wielkie-Tarnow (PL)

(72) Inventor: Wiktor E. Gorowski, Koszyce Wielkie-Tarnow (PL)

(21) Appl. No.: 14/175,251

(22) Filed: Feb. 7, 2014

Related U.S. Application Data
(63) Continuation of application No. 29/468,943, filed on Oct. 4, 2013, now Pat. No. D717128.

(30) Foreign Application Priority Data
Jul. 5, 2013 (PL) P.404580

(51) Int. Cl. A22C 9/00

(52) U.S. Cl. CPC A22C 9/007
USPC 452/146

(57) ABSTRACT

A multi-function meat tenderizing mallet includes a head including a faceplate having a face surface elastically supported by at least one spring, movably mounted on at least one bolt; a shaft attached to the head; and a top plate positioned opposite the faceplate and attached to the shaft via mounting bolts. The faceplate is movably mounted in relation to a set of chopping blades attached to one another by means of at least one mounting bolt. In a rest position the edges of said chopping blades are retracted in the slots of the faceplate.

### PRIORITY

This application is a continuation of U.S. application Ser. No. 29/468,943, filed Oct. 4, 2013, entitled MEAT TENDERIZING MALLET, and claims priority to an application entitled THE MALLET, TYPICALLY FOR TENDERIZING MEAT, filed in the Patent Office of the Republic of Poland on Jul. 5, 2013 and assigned Serial No. P.404580, the contents of each of which are incorporated herein by reference.

### TECHNICAL FIELD

The present disclosure generally relates to a meat tenderizer, and more particularly relates to a multi-function meat tenderizing mallet.

### BACKGROUND

Polish patent specification no. P.391934 provide a meat mallet which comprises a sectioned off faceplate. The meat engaging surface is elastically supported by at least one spring. Said faceplate is movably mounted on at least one bolt. The latter attaches the head of said meat mallet to its handle. Said face plate is movably mounted in relation to a set of chopping blades spaced by a set of spacing sleeves and attached to one another by means of a mounting bolt and/or releasably attached by means of connect bolts. In the position of rest, the edges of said chopping blades are retracted in the slots of said faceplate. Said head is pivotally attached to said handle, preferably by means of said mounting bolt or connect bolt, whereby said head is provided with additional elastic elements attaching said head to said handle. Said faceplate is provided with a guide, preferably with a flow-through slot. Said head is additionally provided with a releasable cover, attached to said faceplate, preferably by means of catches.

This disclosure describes improvements over these prior art technologies.

### SUMMARY

Accordingly, an object of the present disclosure is to provide a multi-function meat tenderizing mallet whose primary function is to tenderize the cohesiveness of muscle fiber structure in the inner and outer layers of meat and flatten meat slices.

A multi-function meat tenderizing mallet includes an obtuse top plate, facing a set of chopping blades and attached to a head by means of connect bolts. The outer edges of said top plate are obtuse. The connecting members of said top plate are of different length.

A main benefit of the present disclosure is the reduction in time necessary to treat meat mechanically, while no chemical substances for corning meat to effect its tenderness are used.

### BRIEF DESCRIPTION OF THE DRAWINGS

The present disclosure will become more readily apparent from the specific description accompanied by the following drawings, in which:

FIG. 1 is a side view of the mallet;

FIG. 2 is a perspective view of said mallet showing the faceplate of its head provided with a plurality of projections;

FIG. 3 is a cross sectional view of said mallet, taken along the axes of the mounting bolts;

FIG. 4 is a side view of the top plate;

FIG. 5 is a front view of said top plate; and

FIG. 6 is a view of said top plate showing its surface with obtuse edges.

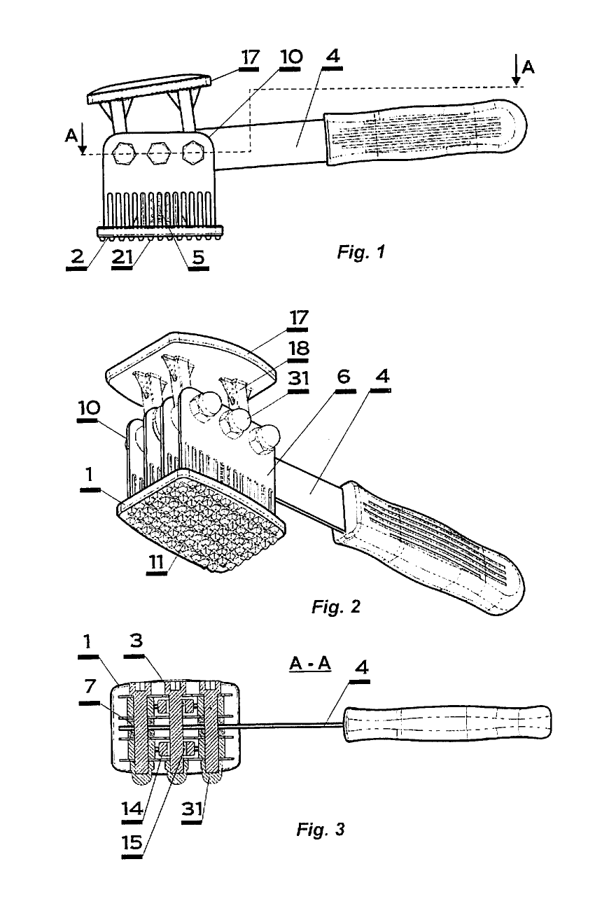

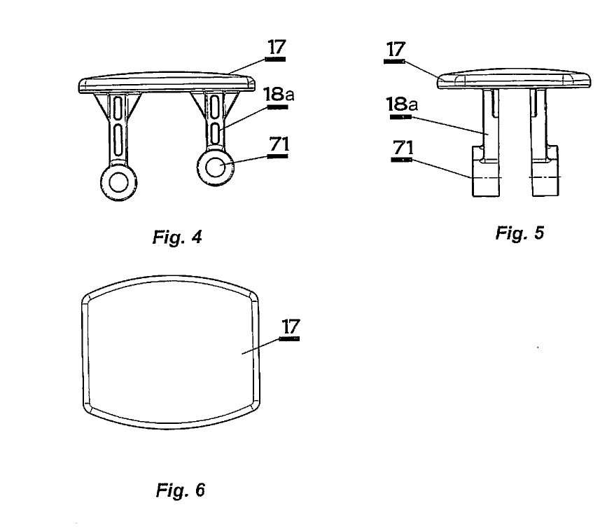

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

A multi-function meat tenderizing mallet according to the present disclosure can includes a shaft with a handle. Attached to shaft 4 is head 10 with face surface 2. Faceplate 1, comprising face surface 2, is sectioned off head 10 and elastically supported by at least one spring 5. Faceplate is movably mounted via at least one bolt 3. Bolt 3 attaches head 10 to shaft 8. Faceplate 1 is also movably mounted in relation to chopping blades 6. Chopping blades 6 are spaced from one another by a set of rings 7 and spacing sleeves 71. Spacing sleeves 71 constitute mounting elements which engage top plate 17 to head 10 and shaft 3 via shorter brackets 18a and longer brackets 18. Obtuse top plate 17, generally facing chopping blades 6, is attached to shaft 4 and secured by means of mounting bolts 3. The outer edges of top plate are obtuse. Longer connecting members 18 and shorter connecting members 18a of top plate 17 are of different length. Chopping blades 6 are secured by mounting bolts 3.

In the position of rest, the ends of chopping blades 6 are retracted in slots 11 of faceplate 1. Faceplate 2 of head 10 comprises guide 14. Preferably, the latter is preferably provided with flow-through slot 15.

The multi-function meat tenderizing mallet disclosed herein can be configured in two main embodiments. In the first, the chopping blades 6 are connected to shaft 4 in a rigid mode. In the second, the chopping blades 6 are connected to shaft 4 in a self-aligning mode.

The mallet includes a shaft 4 with a handle. Attached to shaft 9 is head 10 with face surface 2. Faceplate 1, comprising face surface 2, is sectioned off head 10. To facilitate the process of meat pounding, face surface 2 is provided with pyramid projections 21. Face plate 1 is elastically supported by spring 5, the latter being simultaneously supported by mounting bolt 3 on the opposite end. Face plate 1 is movably mounted on bolt 3. The latter attaches head 10 to shaft 4 and comprises guide 14 with flow-through slot 15 for mounting bolt 3. When a slice of meat is pounded with face surface 2 of faceplate 1 of head 10, projections 21 on face surface 2 penetrate and tenderize meat surface and, due to the resistance that follows, faceplate 1 moves and compresses spring 5. Stainless steel blades 61 of chopping elements 6, which are retracted in slots 11 of faceplate 1 when at rest, cut muscle fibers in meat by penetrating its outer surface. After the pounding force is balanced by the opposite force produced by spring 5, what follows is the reaction of spring compressed by faceplate 1, This, in turn, results in distancing of head 4 from meat surface—a move which is slowed down by the friction from the side surfaces of blades 61 while they are taken out of meat tissue.

Face plate 1 moves against chopping blades 6. The latter are spaced from one another by a set of rings and spacing sleeves which are in contact with head 4. Said chopping blades are releasably attached by mounting bolts 3 provided with nuts 31.

Top plate 17 is used to flatten and pound a slice of meat. Said top plate 17 is engaged to head 10 and shaft 9 via shorter brackets 18a and longer brackets 18 terminated in sleeves.

According to the embodiment of the present invention, the mallet can be easily disassembled for removing remains of muscle fiber and thorough cleaning by quick release of mounting bolts 3, whereupon it can be equally easily reassembled.

To disassemble faceplate 1 of head 10 and top plate 17 in order to remove remains of muscle fiber from slots 11, head 1 must be detached from shaft 4 by undoing nuts 31 and thus releasing mounting bolts 3.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A mutli-function meat tenderizing mallet, comprising:
a head including a faceplate having a face surface elastically supported by at least one spring, said faceplate movably mounted on at least one bolt;
a shaft attached to the head; and
a top plate positioned opposite said faceplate and attached to said shaft via mounting bolts,
wherein said faceplate is movably mounted in relation to a set of chopping blades attached to one another by means of at least one mounting bolt, and
wherein in a rest position the edges of said chopping blades are retracted in the slots of said faceplate.

2. The mallet as set forth in claim 1, wherein outer edges of the top plate are obtuse.

3. The mallet as set forth in claim 1, wherein connecting members of top face are of different lengths.
